(19) United States
(12) Patent Application Publication
(10) Pub. No.: US 2004/0025827 A1
(43) Pub. Date: Feb. 12, 2004

(54) Air cleaner systemwith clear covers for internal combustion engines

(76) Inventor: Steven T. Davis, Green Bay, WI (US)

Correspondence Address: BAKER & DANIELS, 111 E. WAYNE STREET, SUITE 800, FORT WAYNE, IN, 46802

(21) Appl. No.: 10/217,292

(22) Filed: Aug. 12, 2002

(51) Int. Cl. F02B 77/00

(52) U.S. Cl. 123/198 E

(57) ABSTRACT

An air cleaner system for small internal combustion engines, including an air cleaner element which is received within an air cleaner chamber formed within a cover member of the engine. A substantially transparent cover covers the air cleaner chamber and permits viewing of the air cleaner element therethrough, such that an operator may easily determine whether the air cleaner element needs to be replaced. In another aspect, a cover member for attachment to the cylinder head of an engine is provided to define a rocker chamber therebetween, the cover member including a wall portion extending therefrom along the engine cylinder to define an air cooling passage or duct between the wall of the cover member and the engine cylinder. The wall of the cover member directs cooling air downwardly and closely about the engine cylinder to aid in cooling the engine cylinder.

### BACKGROUND OF THE INVENTION

1. Background of the Invention

The present invention relates to small internal combustion engines for use with lawnmowers, lawn tractors, other small utility implements, or sport vehicles. In particular, the present invention relates to air cleaner systems for such small internal combustion engines.

2. Field of the Invention

Small internal combustion engines, such as single or twin cylinder engines, which are used for lawnmowers, lawn tractors, other small utility implements, or sport vehicles, for example, typically include air intake systems having air cleaner devices for removing dirt, dust, and other debris from the atmospheric intake air before the air is drawn into to the engine carburetor for mixing with fuel, followed by combustion within the engine.

For example, in one common arrangement, an air cleaner comprises a separate box-type component including a housing which is mounted to the engine, the housing including an air inlet and an air outlet connected to the air intake system of the engine. Disposed within the air cleaner housing is an air cleaner or filter element for filtering debris from the air. Typically, the housing includes a removable cover for permitting access to the interior of the housing for inspecting and/or replacing the filter element.

Problematically, because the air cleaner housing typically comprises a separate component which is mounted to the engine housing, the air cleaner housing may be difficult to integrate spatially with other engine components such as the fuel tank, the muffler, the recoil starter, and the engine shroud, for example. Additionally, an operator typically must completely remove the cover of the air cleaner housing to inspect the air filter element in order to determine whether the air cleaner element needs to be replaced.

What is needed is an air cleaner system which is an improvement over the foregoing.

### SUMMARY OF THE INVENTION

The present invention provides an air cleaner system for small internal combustion engines, including an air cleaner element which is received within an air cleaner chamber formed within a cover member of the engine, such as a blower housing or shroud. A substantially transparent cover covers the air cleaner chamber and permits viewing of the air cleaner element therethrough, such that an operator may easily determine whether the air cleaner element needs to be replaced. Additionally, the present invention provides an air cleaner subassembly mountable to an engine housing in a single operation, including a main body portion, such as a blower housing which, together with a substantially transparent cover, defines one or more air cleaner chambers in which air cleaner elements are removably mounted.

Advantageously, the foregoing arrangement, by integrating the air cleaner chamber and air cleaner element into an engine covering component, eliminates the need for a separate air cleaner housing attached to the engine, and therefore streamlines the overall engine profile and reduces the amount of space around the engine in which a known air cleaner housing would otherwise occupy. Further, the air cleaner element(s) may be easily viewed through the transparent cover(s) to determined whether the air cleaner element(s) need replacing.

In another aspect, the present invention also provides a cover member for attachment to the cylinder head of an engine to define a rocker chamber therebetween, the cover member covering the valve train components within the rocker chamber. Additionally, the cover member includes a wall portion extending therefrom along the engine cylinder to define an air cooling passage or duct between the wall of the cover member and the engine cylinder. The wall of the cover member directs cooling air downwardly and closely about the engine cylinder to aid in cooling the engine cylinder.

The foregoing cover member integrates a known rocker chamber cover with a wall member or duct for directing cooling air around the engine cylinder, which would otherwise comprise a separate component, thereby reducing the number of components of the engine and facilitating easier assembly of engine.

In one form thereof, the present invention provides an internal combustion engine, including an engine housing; a first cover member covering at least a portion of the engine housing; a second, substantially transparent cover member attached to the first cover member, the first and second cover members together defining an air cleaner chamber therebetween; and an air cleaner element disposed within the air cleaner chamber.

In another form thereof, the present invention provides an internal combustion engine, including an engine housing; a fan rotatably driven by the engine; an air cleaner subassembly mounted to the engine housing, the air cleaner subassembly including a main body portion substantially covering the fan; a substantially transparent cover attached to the main body portion, the main body portion and the cover defining an air cleaner chamber therebetween; and an air cleaner element disposed within the air cleaner chamber.

In a further form thereof, the present invention provides an internal combustion engine, including a crankcase; a cylinder attached to the crankcase, the cylinder having a cylinder head portion in which at least one valve train component is disposed; and a cover member attached to the cylinder head portion, the cylinder head portion and the cover member defining an enclosed chamber in which the at least one valve train element is disposed, the cover member further including a wall portion extending therefrom along the cylinder in a direction away from the cylinder head portion to define an air passage between the wall portion and the cylinder.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is a perspective view of an internal combustion engine according to a first embodiment of the present invention, including a blower housing having a pair of recessed portions within which air cleaner elements are received, and a transparent cover which permits viewing of the air cleaner elements therethrough;

FIG. 2 is a first exploded view of the internal combustion engine of FIG. 1, showing the blower housing, carburetor cover, shroud, transparent cover, and one air cleaner element exploded away from the remainder of the engine;

FIG. 3 is a further exploded view of the engine of FIG. 2, showing the blower housing and a pair of rocker chamber covers exploded away from the engine housing;

FIG. 4 is a perspective view of an internal combustion engine according to a second embodiment of the present invention, including a blower housing defining a recessed portion in which an air cleaner element is disposed, and a transparent cover covering the recessed portion, the transparent cover permitting viewing therethrough; and

FIG. 5 is an exploded view of the internal combustion engine of FIG. 4, showing the transparent cover and the air cleaner element exploded outwardly from the blower housing.

Corresponding reference characters indicate corresponding parts throughout the several views. The exemplifications set out herein illustrates preferred embodiments of the inventions, and such exemplifications are not to be construed as limiting the scope of the invention any manner.

### DETAILED DESCRIPTION

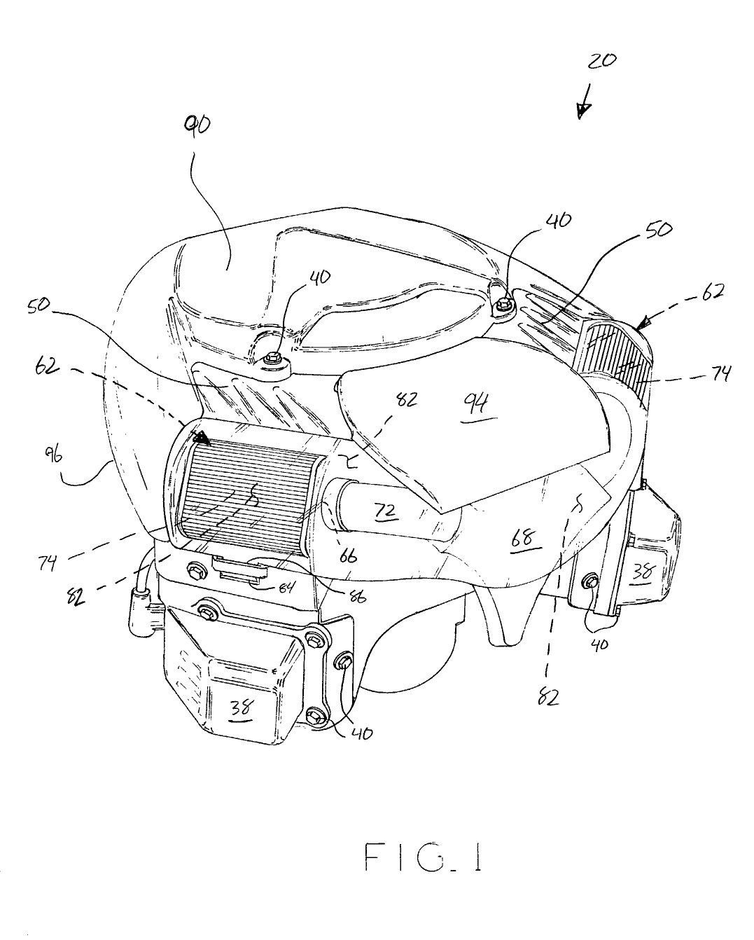

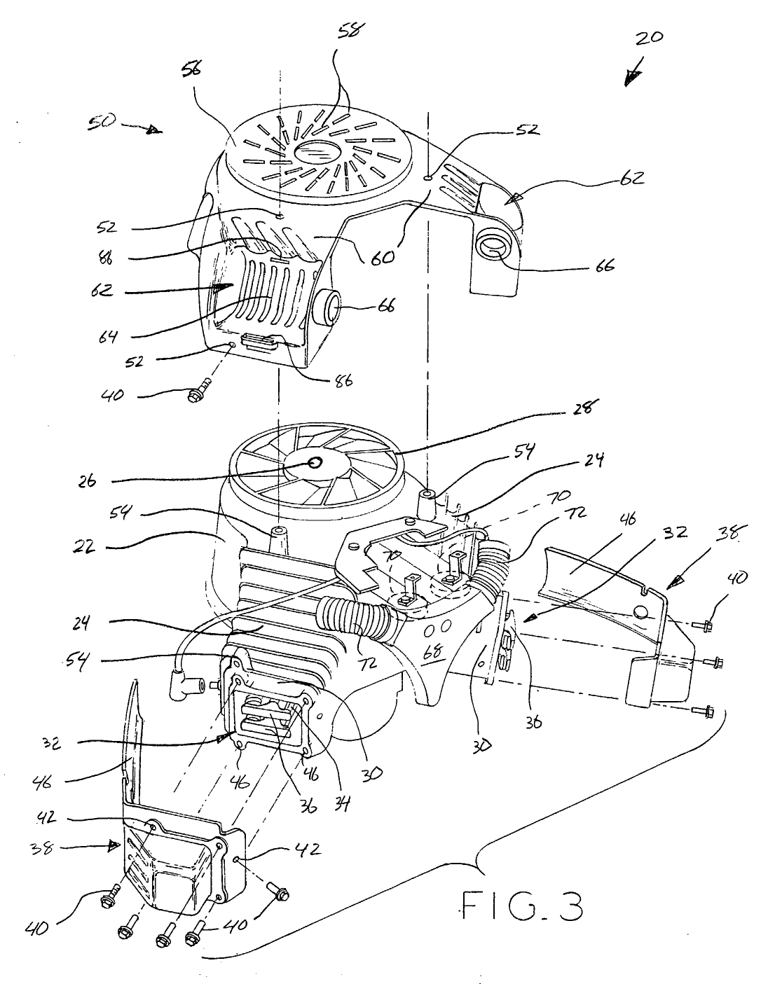

Referring to FIGS. 1-3, internal combustion engine 20, according to a first embodiment of the present invention, is shown. Referring first to FIG. 3, engine 20 is shown as a vertical shaft V-twin engine, including crankcase 22 to which a pair of cylinders 24 are attached. Although the present invention is described herein with reference to twin cylinder engines, the present invention is equally applicable for use with single cylinder engines or with multi-cylinder engines. Crankshaft 26 is rotatably supported within crankcase 22, and includes an outer end extending externally of crankcase 22 to which flywheel/fan 28 is mounted. Cylinders 24 each include cylinder heads 30, which may comprise separate components mounted to cylinders 24, or alternatively, cylinder heads 30 may be formed integrally with cylinders 24. Cylinder heads 30 partially define rocker chambers 32, in which components of the valve train of engine 20 are disposed. Specifically, the valve train includes push rods 34 driven from crankshaft 26 via a camshaft, as known, and rocker arms 36 which are pivotally mounted with respect to cylinder heads for actuating intake and exhaust valves (not shown). Alternatively, the drive train may include an overhead camshaft arrangement, for example.

A rocker chamber cover 38 is mounted to each cylinder head 30 of cylinders 24 to define enclosed rocker chambers 32 therebetween. Specifically, bolts 40 are inserted through apertures 42 in rocker chamber covers 38 and are threaded into bosses 44 in cylinder heads 30 to secure rocker chamber covers 38 to cylinder heads 30. Rocker chamber covers 38 may be made from metal or from a rigid, durable plastic material, for example. Additionally, rocker chamber covers 38 each include wall portions 46 integrally formed therewith, which extend in a direction away from cylinder heads 38 generally toward crankcase 22 of engine 20. Wall portions 46 are disposed adjacent cylinders 24 when rocker chamber covers 38 are attached to cylinder heads, and form cooling air ducts for directing cooling air from fan 28 closely around cylinders 24 of engine 22 to cool same when engine 20 is running. In known engines, separate cooling air ducts are attached to the engine cylinders or blower housing of the engines. Therefore, in the present arrangement, the integration of wall portions 46 with rocker chamber covers 38 reduces the number of components of engine 20 by eliminating the necessity of separate air duct components in addition to the rocker chamber covers, thereby reducing the cost and/or difficulty of assembly of engine 20.

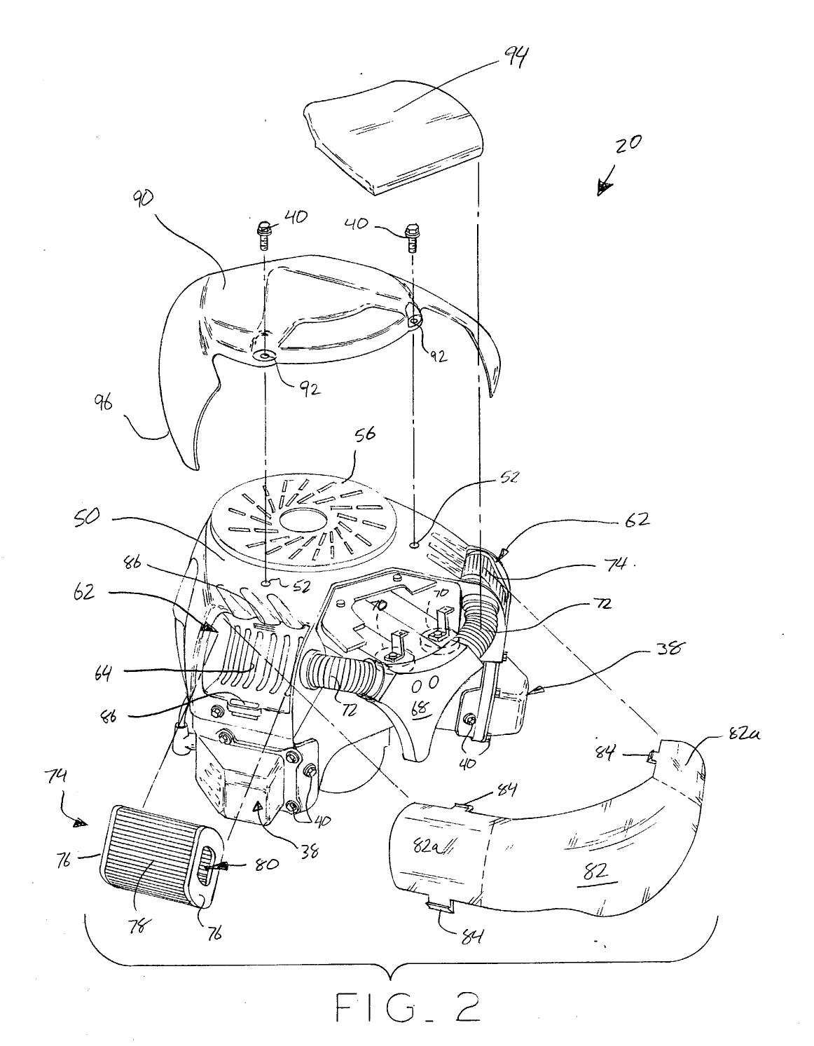

Referring to FIG. 3, blower housing 50 is attached to crankcase 22 by inserting suitable bolts 40 (See also FIG. 2) through apertures 52 in blower housing 50 and into bosses 54 formed in crankcase 22. Blower housing 50 may be formed of a suitable metal or of a plastic material, such as polypropylene or nylon, for example, and includes fan cover portion 56 having a plurality of inlet openings 58 therein through which air may be drawn by fan 28. Blower housing 50 additionally includes a pair of cylinder cover portions 60 extending from fan cover portion 56, each of which includes an air cleaner recess 62 formed therein. Air cleaner recesses 62 each include a plurality of inlet slots 64 allowing air flow into air cleaner recesses 62 from fan 28, and additionally include outlet openings 66 through which air may exit air cleaner recesses 62.

Intake manifold 68 is connected to a pair of carburetors 70, and includes a pair of inlet hoses 72 attached thereto, with opposite ends of the inlet hoses 72 attached to outlet openings 66 of air cleaner recesses 62 of blower housing 50. Referring to FIG. 2, an air cleaner element 74, such as a readily available air filter cartridge, for example, is removably positioned within each air cleaner recess 62 of blower housing 50. Air cleaner element 74 generally includes rim portions 76 and filter media 78 surrounding an open central portion 80.

Additionally, a substantially transparent cover 82, which may be made from a substantially or completely transparent plastic material such as polycarbonate, for example, is provided to cover air cleaner recesses 62, and includes snap tabs 84 which are received within slots 86 in blower housing 50 adjacent air cleaner recesses 62 to thereby attach cover 82 to blower housing 50. Air cleaner recesses and cover 82 together define enclosed air cleaner chambers in which air cleaner elements are disposed. As cover 82 is made from a substantially or completely transparent plastic material, air cleaner elements 74 may be easily viewed therethrough to determine whether air cleaner elements 74 have become soiled or otherwise need replacement. As shown in FIGS. 1 and 2, a single cover 82 covers both of air cleaner recesses 62 of blower housing 50, and additionally includes a central portion which covers intake manifold 68 and inlet hoses 72. Alternatively, as indicated by the dashed lines on cover 82 in FIG. 2, cover 82 may be formed as a pair of separate covers 82a, each covering one air cleaner recess 62 to define a pair of air cleaner chambers. To replace air cleaner elements 74, cover 82 is detached to blower housing be disengaging tabs 84 from slots 86, such as by flexing cover 82. Thereafter, air cleaner elements 74 may be removed from air cleaner recesses 62 and replaced, followed by reattaching cover 82. Also, blower housing 50, air cleaner elements 74, and cover 82 may be pre-assembled as an air cleaner subassembly, which in turn may be attached to crankcase 22 of engine 20 as described above in a single step, thereby facilitating easier manufacturing of engine 20.

Referring to FIGS. 1 and 2, shroud 90 may be attached to blower housing 50 by bolts 40 inserted through apertures 92 in shroud 90 and through apertures 52 in blower housing 50 into bosses 54 of crankcase 22. Shroud includes lower edge 96 extending therearound, which is spaced outwardly from blower housing 50 to define a gap therebetween. Additionally, carburetor cover 94 may be attached to blower housing 50 between extending portions 60 thereof in a suitable manner to cover carburetors 70 and the linkage assemblies associated therewith. Thus, as may be seen in FIGS. 1-3, the incorporation of air cleaner recesses 62 into blower housing 50 eliminates the need for a separate air cleaner housing, thereby streamlining the overall profile of engine 20, and positioning air cleaner elements 74 toward the front of engine 20 for easy viewing through cover 82.

In operation, during running of engine 20, fan 28 draws air from beneath lower edge 96 of shroud 90 between shroud 90 and blower housing 50 into the space between the shroud 90 and blower housing 50, and thence through inlet apertures 56 in fan cover portion 56 of blower housing 50 and into the space between blower housing 50 and crankcase 22. Thereafter, the air is directed outwardly of fan 28, and enters air cleaner chambers 62 through inlet slots 64, and passes through filter media 78 of air cleaner elements 74, where debris is filtered from the air, into open central portion 80 of air cleaner elements 74 before exiting the air cleaner chambers through outlets 66. Thereafter, the cleaned air passes through intake hoses 72 into intake manifold 68 and thence into carburetors 70 and into the intake system of engine 20.

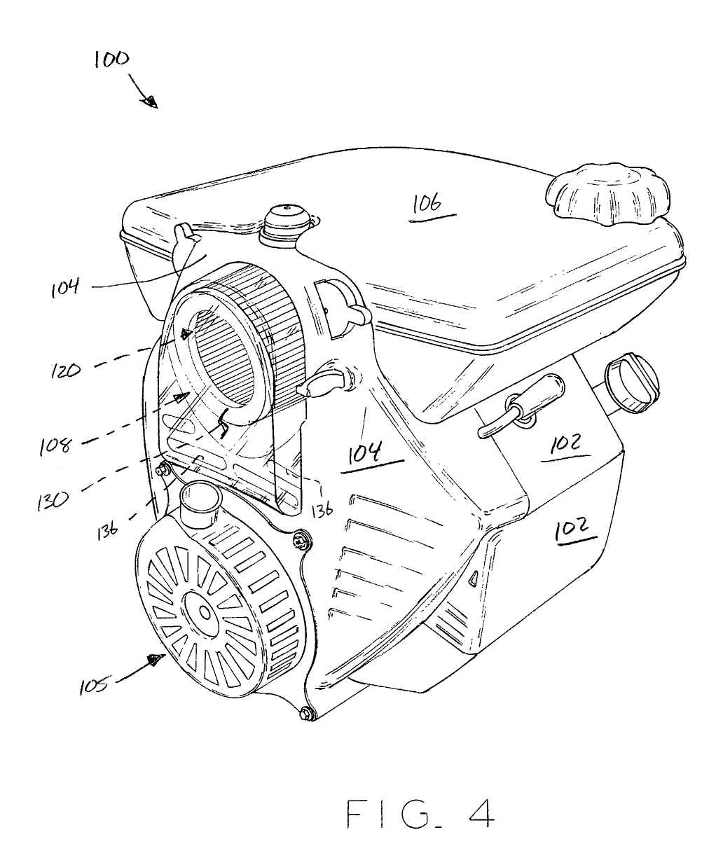

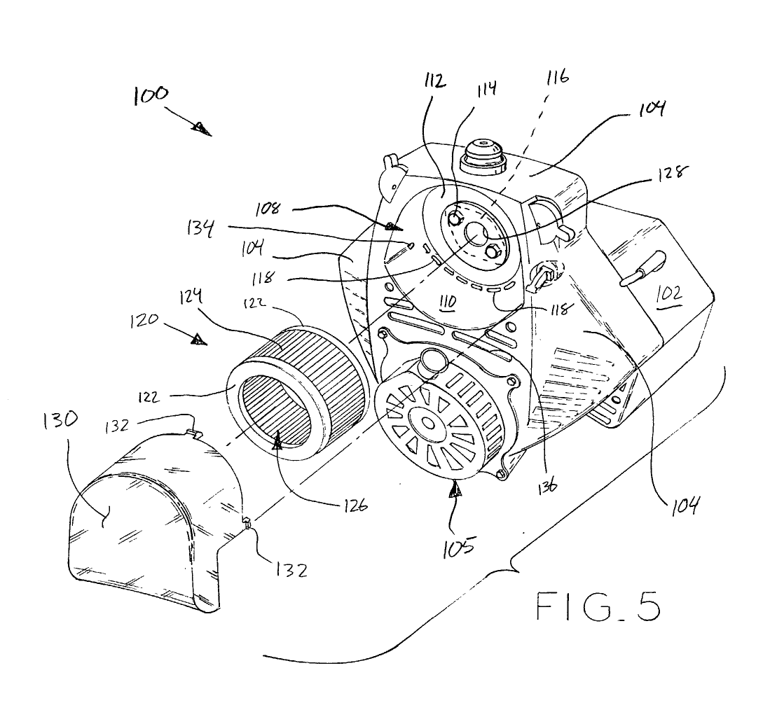

Referring to FIGS. 4 and 5, another embodiment of the present invention is shown in connection with a horizontal shaft V-twin engine 100. Engine 100 is of the type disclosed in further detail in U.S. Provisional Patent Application Serial No. 60/372,560, entitled INTERNAL COMBUSTION ENGINE, filed on Apr. 15, 2002, and in U.S. Provisional Patent Application Serial No. ______, entitled INTERNAL COMBUSTION ENGINE, filed on Aug. 12, 2002, each assigned to the assignee of the present application, the disclosure of which is expressly incorporated herein by reference. Engine 100 generally includes a crankcase and a pair of cylinders (not shown) which are covered by cylinder wraps 102. Blower housing 104 is attached to the crankcase, and recoil starter assembly 105 is attached to blower housing 104 and to the crankcase. A fuel tank 106 is attached to cylinder wraps 102 and/or crankcase in a suitable manner.

Referring to FIG. 5, blower housing 104 includes air cleaner recess 108 integrally formed therein, which includes side wall 110 and rear wall 112. Bolts 114 are inserted through apertures in rear wall 112 to connect same to attachment flange 116 of a carburetor (not shown). Side wall 110 of air cleaner recess 108 includes a plurality of air inlet openings 118 therein, and rear wall 112 includes outlet opening 128 aligned with attachment flange 116 of the carburetor.

Air cleaner element 120, shown as an annular air filter, is received within air cleaner recess 108 of blower housing 104, and generally includes rim portions 122 and filter media 124 surrounding open central portion 126. When air cleaner element 120 is placed within air cleaner recess 108, one of the rim portions 122 thereof seats against rear wall 112 of air cleaner recess 108, with open central portion 126 of air cleaner element 120 aligned with outlet opening 128, and inlet openings 118 disposed around filter media 124 of air cleaner element 120 and spaced therefrom. A transparent cover 130, made from a substantially transparent or completely transparent plastic, for example, includes attachment tabs 132 which are received within slots 134 within air cleaner recess 108 of blower housing 104 to enclosed air cleaner recess 108 and define and air cleaner chamber therebetween in which air cleaner element 120 is received. To replace air cleaner element 120, cover 130 is detached from blower housing 104 by disengaging tabs 132 from slots 134, such as by flexing cover 130. Thereafter, air cleaner element 120 may be removed from air cleaner recesses 108 and replaced, followed by reattaching cover 130. Advantageously, air cleaner recess 108 of blower housing 104 is positioned in the front of engine 100, such that air cleaner element 120 may be easily viewed through cover 130.

In operation, intake air enters air cleaner recess 108 through inlet openings 118 and passes through filter media 124 of air cleaner element, where debris is filtered from the air, into open central portion 126 of air cleaner element 120. Alternatively, intake air may also enter air cleaner recess 108 through slotted openings 136 in shroud 104. Thereafter, the cleaned intake air exits air cleaner recess 108 through outlet opening 128 thereof and enters the carburetor, where the intake air is mixed with gasoline to form a combustion mixture for combustion within the engine 100.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An internal combustion engine, comprising:
an engine housing;
a first cover member covering at least a portion of said engine housing;
a second, substantially transparent cover member attached to said first cover member, said first and second cover members together defining an air cleaner chamber therebetween; and
an air cleaner element disposed within said air cleaner chamber.

2. The internal combustion engine of claim 1, further including a fan driven by said engine, and wherein said first cover member comprises a blower housing substantially covering said fan.

3. The internal combustion engine of claim 2, further including a shroud covering at least a portion of said blower housing.

4. The internal combustion engine of claim 1, wherein said first cover member includes at least one first opening therein through which air may enter said air cleaner chamber, and at least one second opening therein through which air may exit said air cleaner chamber.

5. The internal combustion engine of claim 1, wherein said second cover member is removably attached to said first cover member, and said air cleaner element is removably mounted within said air cleaner chamber.

6. The internal combustion engine of claim 1, wherein said first cover member and said second cover member together define a pair of air cleaner chambers therebetween, each said air cleaner chamber having an air cleaner element therein.

7. An internal combustion engine, comprising:
an engine housing;
a fan rotatably driven by said engine;
an air cleaner subassembly mounted to said engine housing, said air cleaner subassembly comprising:
a main body portion substantially covering said fan;
a substantially transparent cover attached to said main body portion, said main body portion and said cover defining an air cleaner chamber therebetween; and
an air cleaner element disposed within said air cleaner chamber.

8. The internal combustion engine of claim 7, wherein said main body portion includes at least one first opening therein through which air may enter said air cleaner chamber from said fan, and at least one second opening therein through which air may exit said air cleaner chamber.

9. The internal combustion engine of claim 7, wherein said cover is removably attached to said main body portion, and said air cleaner element is removably mounted within said air cleaner chamber.

10. The internal combustion engine of claim 7, further including at least one carburetor attached to said engine housing, and wherein said air cleaner subassembly further includes a conduit communicating said air cleaner chamber with said carburetor.

11. The internal combustion engine of claim 7, wherein said main body portion of said air cleaner subassembly includes two said covers, said main body portion and said covers defining two air cleaner chamber therebeween for receipt of two air cleaner elements.

12. An internal combustion engine, comprising:
a crankcase;
a cylinder attached to said crankcase, said cylinder having a cylinder head portion in which at least one valve train component is disposed; and
a cover member attached to said cylinder head portion, said cylinder head portion and said cover member defining an enclosed chamber in which said at least one valve train element is disposed, said cover member further including a wall portion extending therefrom along said cylinder in a direction away from said cylinder head portion to define an air passage between said wall portion and said cylinder.

13. The internal combustion engine of claim 12, wherein said cylinder head portion and said cover member define a rocker arm chamber, and said at least one valve train component includes a pair of rocker arms disposed in said rocker arm chamber, said rocker arms operably attached to a pair of valves.
